(19) United States
(12) Patent Application Publication
(10) Pub. No.: US 2007/0074827 A1
(43) Pub. Date: Apr. 5, 2007

(54) Side-Window Shade

(76) Inventor: Yair Avitsur, Raanana (IL)

Correspondence Address: DR. MARK M. FRIEDMAN;C/O BILL POLKINGHORN - DISCOVERY DISPATCH, 9003 FLORIN WAY, UPPER MARLBORO, MD, 20772, US

(21) Appl. No.: 11/464,197

(22) Filed: Aug. 13, 2006

(30) Foreign Application Priority Data
Aug. 15, 2005 (IL) 170277

(51) Int. Cl. E06B 3/32

(52) U.S. Cl. 160/90

(57) ABSTRACT

A side window shade system and method, the method including the steps of: (a) providing an opaque, generally planar, flexible window shade, a first dimension of the shade having a length of 18 cm to 30 cm, and a second dimension of the shade, perpendicular to the first dimension, having a length of at least 12 cm, the first dimension of the shade having, a first edge having a thickness in a range of about 0.6 mm to about 1.0 mm; (b) positioning the window shade along an inner face of the side window, and (c) wedging the first edge of the shade between the side window and a window frame of the window, so as to reversibly secure the shade in a shading position on the inner face of the side window.

This application draws priority from Israel Patent Application Serial No. 170277, filed Aug. 15, 2005.

### FIELD AND BACKGROUND OF THE INVENTION

The present invention relates to a vehicle window shade, and more particularly, to a side-window shade for reversibly mounting on the side window by urging an edge of the shade into a crevice between the side window and the side window frame of the vehicle.

Planet Earth is presently undergoing an accelerated heating process. This heating process is accompanied by extensive damage to the ozone layer, which filters out the harmful ultraviolet portion of the sun's radiation Consequently, exposure to sunlight becomes more dangerous, as this exposure may promote premature aging of the skin and/or skin cancer.

Window shades are well known in the art and are traditionally used to shade a window from sunlight, The use of window shades is increasingly important in view of the increased ultraviolet radiation reaching the Earth.

Various vehicle shade accessories have been developed to reduce the exposure of the driver and the vehicle passengers to sunlight. Such shade accessories may be broken into two main categories, according to their mode of use.

One category includes those accessories that are attached to the front and rear windows of the vehicle and serve to reduce heating of the interior of the vehicle when exposed to sunlight while parked. Falling into this category are, for example, cardboard-made accordion-like devices which can be extended in use and collapsed or folded when stored and rollable screens contained in a housing attached to the front window in a rolled configuration when not in use and unrolled when used. Shade accessories in this category are typically fully opaque, or opaque and reflective, cover substantially the entire window, and are suitable solely for use in parked vehicles.

Another category includes those shade accessories for attaching to the side and optionally the rear vehicle windows and which serve to reduce the intensity of sunlight to which the driver is exposed while the vehicle is driven. Some accessories of this category, such as curtains, are opaque and may be unlawful because they interfere with or obstruct the eye contact of the driver with the side mirrors of the vehicle. Additionally, such shade accessories may be unlawful because they interfere with or obstruct the eye contact of law enforcement personnel approaching the vehicle, who must be able to easily see the upper body portion of both the driver and the passengers in the vehicle.

In many cases, accessories of this category have a perforated surface, which reduces sunlight intensity. However, the perforations or openings fail to filter out light, and more particularly, damaging wavelengths thereof, such as ultraviolet radiation. In addition, such perforated surfaces are typically attached to the window itself via stickers or vacuum devices, limiting the utility of such accessories.

There is thus a widely recognized need for, and it would be highly advantageous to have, a vehicle side-window shade that is simple and efficient, that is securably but non-permanently deployable, and can be repositioned on the side window with facility, even using a single hand while driving It would be of further advantage to have a side-window shade that is thin and compact, such that the mounting of the shade is not is not a source of discomfort or distraction for the driver or passengers.

### SUMMARY OF THE INVENTION

According to the teachings of the present invention there is provided a method of securing a shade to a side window of a motor vehicle, the method including the steps of: (a) providing an opaque, generally planar, flexible window shade, a first dimension of the shade having a length of 18 cm to 30 cm, and a second dimension of the shade, perpendicular to the first dimension, having a length of at least 12 cm, the first dimension of the shade having a first edge having a thickness in a range of about 0.6 mm to about 1.0 mm; (b) positioning the window shade along an inner face of the side window, and (c) wedging the first edge of the shade between the side window and a window frame of the window, so as to reversibly secure the shade in a shading position on the inner face of the side window.

According to another aspect of the present invention there is provided a side window vehicle shade system, including an opaque, generally planar, substantially gamma-shaped window shade, for reversibly securing to a side window of a motor vehicle, so as to at least partially shade a face of a passenger sitting by the window, wherein the gamma-shaped shade has a horizontal leg and an upright leg, the horizontal leg having a width in a range of 10 cm to 18 cm, the horizontal leg including a first edge designed for wedging between the side window and a window frame of the window to effect the securing, the edge having a thickness in a range of about 0.6 mm to about 1.0 mm, and wherein the upright leg of the gamma-shaped shade is dimensioned and configured to serve as a handle for positioning and securing the shade on the side window.

According to farther features in the described preferred embodiments, the window shade is a substantially gamma-shaped window shade

According to still further features in the described preferred embodiments, the gamma-shaped shade has a horizontal lea and an upright leg, the horizontal leg having a length corresponding to the first dimension, and a width in a range of 10 cm to 18cm.

According to further features in the described preferred embodiments, the maximal thickness of the side window shade less than about 2 mm, preferably less than 1 mm.

According to still further features in the described preferred embodiments, the upright leg extends at least 3 cm below the horizontal leg.

According to still further features in the described preferred embodiments, the upright leg extends at least 6 cm below the horizontal leg.

According to still further features in the described preferred embodiments, the upright leg serves as a handle for effecting the positioning.

According to still further features in the described preferred embodiments, the flexible window shade is unitary.

According to still further features in the described preferred embodiments, the flexible window shade includes polypropylene.

According to still further features in the described preferred embodiments, the flexible window shade consists substantially of polypropylene.

According to still further features in the described preferred embodiments, the flexible window shade is substantially impervious to heat.

According to still further features in the described preferred embodiments, the flexible window shade has a global area of at least 350 square centimeters, the global area including a contiguous open area of at least 60 square centimeters.

According to still further features in the described preferred embodiments, the flexible window shade has a global area of at least 450 square centimeters, the global area including a contiguous open area of at least 80 square centimeters.

According to still further features in the described preferred embodiments, the flexible window shade has a global area of at least 450 square centimeters, the global area including a contiguous open area of at least 100 square centimeters.

According to still further features in the described preferred embodiments, the positioning of the window shade and the wedging are performed by an occupant of the vehicle using a single hand. Preferably, the gamma-shaped shade and the handle-like protrusion thereof are dimensioned and configured such that a driver of the motor vehicle can safely and easily position and secure (as well as detach, reposition, and resecure) the shade on the side window with a single hand, while driving

According to still further features in the described preferred embodiments, the system further includes the side window and the side window frame.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice. Throughout the drawings, like-references characters are used to designate like elements. In the drawings:

FIG. 1a is a schematic perspective representation of the side window vehicle shade of the present invention;

FIG. 1b is a schematic perspective representation of a car and driver, wherein the side window of the driver is equipped with the inventive vehicle shade of FIG. 1a;

FIG. 2 is a schematic, portional cross-sectional view of the side window vehicle shade system of the present invention, and

FIG, 3 is a schematic representation of the side window vehicle shade of the present invention, projected onto an imaginary rectangle, so as to define a contiguous open area adjacent to the inventive side window vehicle shade.

### DESCRIPTION OF THE PREFERRED EMBODIMENTS

One embodiment of the present invention is a side window vehicle shade, and a method of using the shade on a side window of a motor vehicle. The inventive window shade has certain advantages over prior art designs in that it is easily positioned, secured, detached, and repositioned. Moreover, the shade largely maintains the functionality of the side window, allowing the driver to maintain eye contact with the side mirrors of the vehicle and allowing law enforcement personnel to view the upper body portions of vehicle occupants.

The principles and operation of the side window shade of the present invention may be better understood with reference to the drawings and the accompanying description.

Before explaining at least one embodiment of the invention in detail, it is to be understood that the invention is not limited in its application to the details of construction and the arrangement of the components set forth in the following description or illustrated in the drawing. The invention is capable of other embodiments or of being practiced or carried out in various ways. Also, it is to be understood that the phraseology and terminology employed herein is for the purpose of description and should not be regarded as limiting.

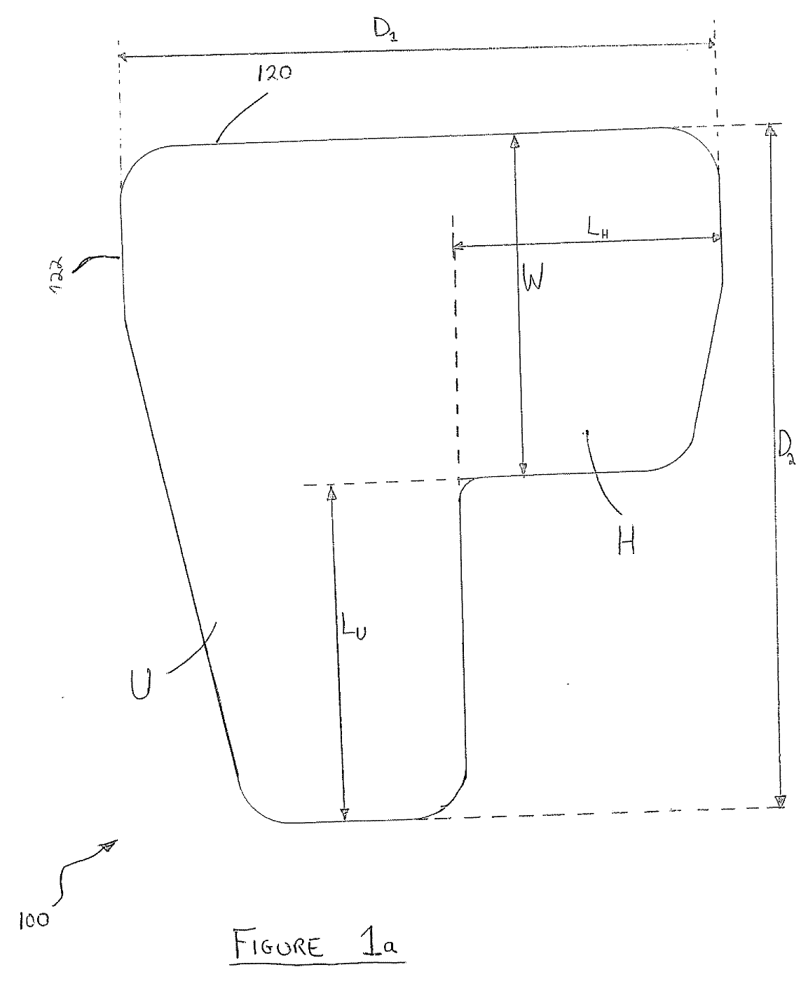

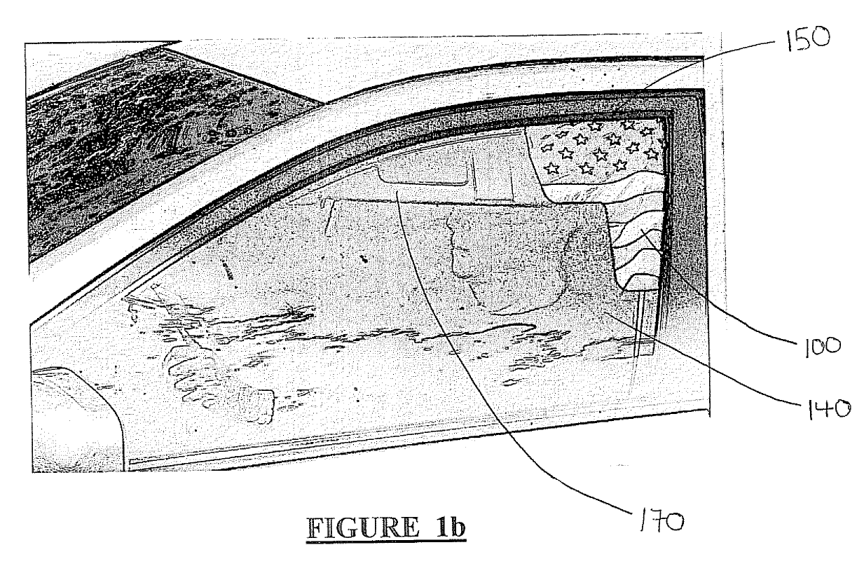

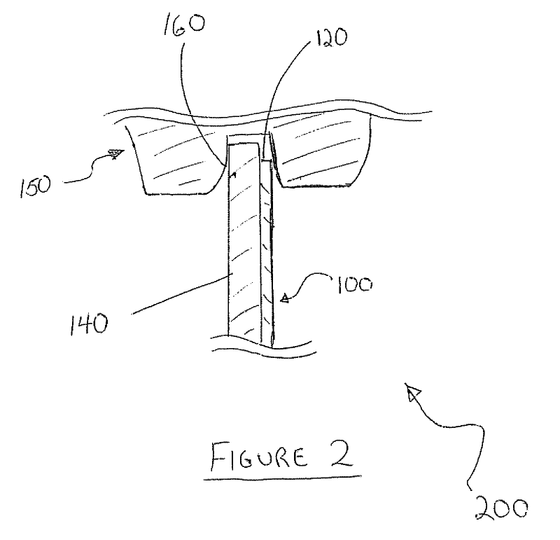

Referring now to the drawings, FIG. 1a is a schematic perspective representation of a side window vehicle shade 100 according to the present invention, Side window vehicle shade 100 is opaque and generally planar, and is preferably shaped like the Creek letter gamma (“Γ”). Thus, vehicle shade 100 has a horizontal leg H and an upright leg (or handle) U.

As used herein in the specification and in the claims section that follows, the term “gamma-shaped”, and the like, with respect to a window shade, is specifically meant to include generally T-shaped window shades.

As used herein in the specification and in the claims section that follows, the term “opaque”, with respect to a window shade, refers to a protective optical quality of the shade, wherein at least 95% of light in the visible and ultraviolet range of wavelengths fails to completely penetrate the shade.

Side window vehicle shade 100 has a first dimension D₁and a second dimension D₂ that is perpendicular to first dimension D₁. The protrusion of horizontal leg H beyond upright leg U, and in a direction parallel to that of first dimension D₁, defines L_{H}. The protrusion of upright leg U beyond horizontal leg H, and in a direction parallel to that of first dimension D₂, defines Lᵤ. The (maximal) width of horizontal leg H defines W. The significance of these parameters will be described hereinbelow.

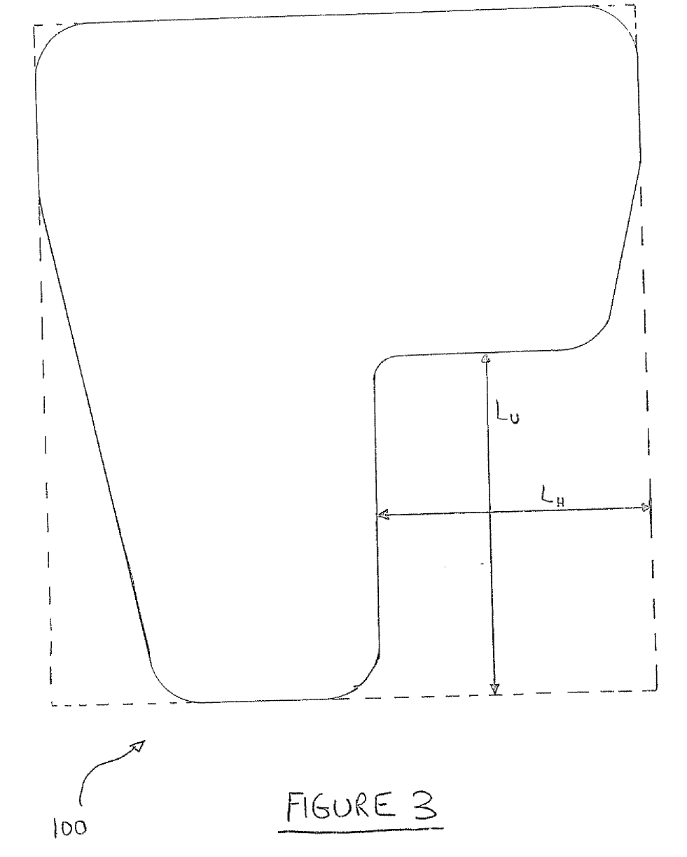

As will be described in further detail with reference to FIG. 2, side window vehicle shade 100 is secured to a side window frame of a motor vehicle, by wedging a first edge 120 of shade 100 between the side window and a window frame of the side window It may be possible, alternatively or additionally, to wedge a second edge 122 of shade 100 into a side area of the window frame.

FIG. 1b is a schematic perspective representation of a motor vehicle and driver, wherein a side window 140 of the driver is equipped with an inventive vehicle shade 100. A positionable sun visor 170, such as one normally supplied by the car manufacturer, is disposed along the top of side window 140. Preferably, first dimension D₁ of vehicle shade 100 should be of sufficient length such that vehicle shade 100 and sun visor 170 meet or overlap when vehicle shade 100 is disposed in the rear corner of side window 140.

FIG. 2 is a schematic, portional cross-sectional view of a side window vehicle shade system 200 of the present invention. Shade system 200 includes side window vehicle shade 100, side window 140, and side window frame 150 for receiving side window 140 when window 140 is in a closed or nearly-closed position. Window frame 150, which is preferably the conventional (ire., supplied by the car manufacturer or identical thereto) window frame for side window 140, typically has a flexible inner surface or lip 160 for flexibly adapting to, and sealing around, a top portion of side window 140. Thus, by juxtaposing first edge 120 of shade 100 between side window 140 and window frame 150, flexible inner surface 160 flexibly adapts to, and seals around, both the top portion of side window 140 and first edge 120.

To this end, vehicle shade 100 is preferably flexible, and has a thickness of less than or equal to 12 mm, preferably less than or equal to 10 mm, more preferably, less than or equal to 9 mm, and most preferably, less than or equal to about 8 mm. However, due to mechanical strength and other considerations (for suitable materials such as polypropylene), vehicle shade 100 preferably has a thickness of more than 5 mm, and preferably more than about 6 mm. Taking into account all of the considerations then, vehicle shade 100 preferably has a thickness in the range of 6 mm to 10 mm, and more preferably, in the range of 7 mm to 9 mm.

Construction materials for the shade of the present invention are substantially impervious to sunlight, such that they do not wilt or release toxic gases upon extended exposure to sunlight and to heat build-up within the vehicle.

Side window vehicle shade 100 is secured to a side window frame of a motor vehicle, by first positioning shade 100 along an inner face of side window 140, and wedging a first edge 120 of shade 100 between side window 140 and window frame 120, so as to secure shade 100 in a shading, position, in a reversibly attachable fashion, on the inner face of the side window. Side window vehicle shade 100 is easily secured in a different position with respect to the side window by slightly lowering the side window, repositioning shade 100 along the length of the window, and again wedging first edge 120 of shade 100 between the side window and the window frame of the side window Alternatively, shade 100 can be pulled away from window frame 120, repositioned with respect to side window 140 and resecured in a shading position by inserting or wedging first edge 120 of shade 100 between side window 140 and frame 150.

As used herein in the specification and in the claims section that follows, the term “reversibly attachable” and the like, with respect to a window shade and vehicle window, refers to a securing of the shade to the window in a repeatable manner, and in a non-destructive fashion, with respect to the shade, the window, the window frame, and the interior surface surrounding the window.

FIG. 3 is a schematic representation of the side window vehicle shade of the present invention, projected onto an imaginary rectangle, so as to define contiguous open areas adjacent to the inventive side window vehicle shade.

As used herein in the specification and in the claims section that follows, the term “contiguous open area”, and the like, with respect to a window shade, refers to the product of L_{H}, and Lᵤ (as described hereinabove):
contiguous open area=L_{H}×L_{U}

As used herein in the specification and in the claims section that follows, the term “global area” refers to the product of the first dimension D₁ and the second dimension D₂:
global area=D₁×D₂

First dimension D₁ has a length of at least 16 cm, more preferably, at least 18 cm, and most preferably, at least 20 cm. The maximal length of first dimension D₁ is about 30 cm. Second dimension D₂ has a minimum length of at least 10 cm, if the shade is substantially rectangular Preferably, the shade is gamma-shaped, with the width W of horizontal leg H being at least 10 cm. More narrow shades do not effectively protect the driver or passenger from sunlight beaming into the vehicle through the side windows The upper bound of width W is such that the view of traffic, by the driver, is largely unimpaired. In virtually all passenger vehicles, width W must be less than 18 cm, more typically, less than 15 cm.

Preferably, upright leg or handle U is dimensioned and configured to serve as a handle for positioning and securing window shade 100 on side window 140, Upright leg U is further dimensioned and configured to protect the neck of the driver or passenger from sunlight entering the vehicle through the side window Consequently, L_{U}, the protrusion of upright leg U beyond horizontal leg H, is preferably at least 3 cm, in order to serve as a handle. More preferably, the protrusion should be at least 6 cm. For protection of the neck, however, it is preferable for the protrusion to be at least 8 cm, and more preferably, at least 10 cm.

The inventor has further discovered a relationship between global area and contiguous open area in side window shades according to the present invention. It is well understood that generally speaking, increased shading area is associated with increased protection from sunlight, and is further associated with increased obstruction of view. The contiguous open area, as defined, provides a “window” that improves the field of vision of the driver. A large, contiguous open area enables the window shade to have a large shading area without unreasonable obstruction of view. Moreover, a particular relationship between the global area and the contiguous open area enables the shading area of the shade, when mounted on the side window, to be effectively disposed so as to block sunlight from the side window from reaching the head and neck of the driver. Preferably, the window shade has a global area of at least 350 square centimeters, the global area including a contiguous open area of at least 60 square centimeters. More preferably, the global area is at least 450 square centimeters, and contains a contiguous open area of at least 80 square centimeters. Most preferably, the global area is at least 450 square centimeters, and contains a contiguous open area of at least 100 square centimeters.

Although the invention has been described in conjunction with specific embodiments thereof, it is evident that many alternatives, modifications and variations will be apparent to those skilled in the art, Accordingly, it is intended to embrace all such alternatives, modifications and variations that fall within the spirit and broad scope of the appended claims.

What is claimed is:

1. A method of securing a shade to a side window of a motor vehicle, the method comprising the steps of:
(a) providing an opaque, generally planar, flexible window shade, a first dimension of said shade having a length of 18 cm to 30 cm, and a second dimension of said shade, perpendicular to said first dimension, having a length of at least 12 cm, said first dimension of said shade having a first edge having a thickness in a range of about 0.6 mm to about 1.0 mm;
(b) positioning said window shade along an inner face of the side window, and
(c) wedging said first edge of said shade between the side window and a window frame of said window, so as to reversibly secure said shade in a shading position on said inner face of the side window.

2. The method of claim 1, wherein said window shade is a substantially gamma-shaped window shade.

3. The method of claim 2, wherein said gamma-shaped shade has a horizontal leg and an upright leg: said horizontal leg having a length corresponding to said first dimension, and a width in a range of 10 cm to 18 cm.

4. The method of claim 3, wherein said upright leg extends at least 3 cm below said horizontal leg.

5. The method of claim 3, wherein said upright leg extends at least 6 cm below said horizontal leg.

6. The method of claim 3, wherein said upright leg serves as a handle for effecting said positioning.

7. The method of claim 2, wherein said flexible window shade is unitary.

8. The method of claim 1, wherein said flexible window shade consists substantially of polypropylene.

9. The method of claim 2, wherein said flexible window shade has a global area of at least 350 square centimeters, said global area including a contiguous open area of at least 60 square centimeters.

10. The method of claim 2, wherein said flexible window shade has a global area of at least 450 square centimeters, said global area including a contiguous open area of at least 80 square centimeters.

11. The method of claim 2, wherein said flexible window shade has a global area of at least 450 square centimeters, said global area including a contiguous open area of at least 100 square centimeters.

12. The method of claim 1, wherein said positioning of said window shade and said wedging are performed by an occupant of the vehicle using a single hand.

13. A side window vehicle shade system, comprising:
an opaque, generally planar, substantially gamma-shaped window shade, for reversibly securing to a side window of a motor vehicle, so as to at least partially shade a face of a passenger sitting by said window,
wherein said gamma-shaped shade has a horizontal leg and an upright leg, said horizontal leg having a width in a range of 10 cm to 18 cm,
said horizontal leg including a first edge designed for wedging between said side window and a window frame of said window to effect said securing, said edge having a thickness in a range of about 0.6 mm to about 1.0 mm.
and wherein said upright leg of said gamma-shaped shade is dimensioned and configured to serve as a handle for positioning and securing said shade on said side window.

14. The side window vehicle shade system of claim 13, wherein said gamma-shaped shade and said handle are dimensioned and configured such that a driver of the motor vehicle can safely position and secure said shade on said side window with a single hand, while driving.

15. The side window vehicle shade system of claim 14, wherein said flexible window shade has a global area of at least 350 square centimeters, said global area including a contiguous open area of at least 60 square centimeters.

16. The side window vehicle shade system of claim 13, wherein said flexible window shade has a global area of at least 450 square centimeters, said global area including a contiguous open area of at least 80 square centimeters.

17. The side window vehicle shade system of claim 13, wherein said flexible window shade includes polypropylene.

18. The side window vehicle shade system of claim 13, wherein said flexible window shade is unitary, and consists substantially of polypropylene.

19. The side window vehicle shade system of claim 13, wherein said flexible window shade is substantially impervious to heats.

20. The side window vehicle shade system of claim 13, the system further comprising said side window and said window flame.
